(19) United States
(12) Patent Application Publication
(10) Pub. No.: US 2014/0261573 A1
(43) Pub. Date: Sep. 18, 2014

(54) SYSTEM AND METHOD FOR USING AN ACETONE SOLVENT TO CLEAN MANUFACTURING EQUIPMENT USED TO MANUFACTURE COMPOSITE SANDWICH PANELS

(71) Applicant: LPORT ASSOCIATES S.A., City of Panama (PA)

(72) Inventor: Ulrich Schwartau, Port d Andratx (ES)

(73) Assignee: MILLPORT ASSOCIATES S.A., City of Panama (PA)

(21) Appl. No.: 13/826,094

(22) Filed: Mar. 14, 2013

(51) Int. Cl. B08B 3/04

(52) U.S. Cl. CPC B08B 3/04
USPC 134/34; 134/184

(57) ABSTRACT

A system and method for cleaning one or more components used to manufacture composite sandwich panels, which uses an acetone solvent and increased pressure to facilitate cleaning manufacturing equipment used to produce composite sandwich panels. The acetone solvent may be pressurized to enhance cleaning of the contaminated manufacturing equipment. A trough may be positioned to receive the acetone solvent for re-use.

### TECHNICAL FIELD OF THE INVENTION

The present invention relates generally to cleaning manufacturing equipment, and more particularly, to a system and method for using an acetone solvent for cleaning manufacturing equipment used to manufacture composite sandwich panels.

### DESCRIPTION OF THE RELATED ART

There is an increasing global demand for lower-cost buildings such as houses, warehouses and office space. The demand for lower cost buildings is particularly strong in developing countries where economic resources may be limited and natural resources and raw materials may be scarce. For example, in areas of the Middle East or Africa, conventional building materials such as cement, brick, wood or steel may not be readily available or, if available, may be very expensive. In other areas of the world, poverty may make it too costly for people to build houses or other buildings with conventional materials.

The demand for lower-cost housing also is high in areas afflicted by war or natural disasters, such as hurricanes, tornados, floods, and the like. These devastating events often lead to widespread destruction of large numbers of buildings and houses, especially when they occur in densely populated regions. The rebuilding of areas affected by these events can cause substantial strain on the supply chain for raw materials, making them difficult or even impossible to obtain. Furthermore, natural disasters often recur and affect the same areas. If a destroyed building is rebuilt using the same conventional materials, it stands to reason that the building may be destroyed or damaged again during a similar event.

It is generally desirable to increase speed of construction and to minimize construction costs. Prefabricated or preassembled components can streamline production and reduce both the time and the cost of building construction. Prefabricated buildings, however, are made from conventional materials and may be scarce or expensive to obtain. Thus, there exists a need for alternative materials and techniques for constructing buildings that use advanced material technologies to increase the speed of construction and also reduce or lower ownership costs. Likewise a need exists for increasing manufacturing efficiencies associated with the production of such prefabricated or preassembled components.

### SUMMARY

The present invention provides an alternative to conventional construction materials and techniques. Buildings, such as houses, commercial buildings, warehouses, or other structures can be constructed by composite sandwich panels (also referred to as “sandwich panels” or “composite panels” or “panels”), which have an insulative core and one or more outer layers, for example, layers of laminate. The buildings can be constructed by gluing several sandwich panels together, and usually traditional fasteners, such as screws, rivets, nails, etc., are not needed for such connections. Generally, composite sandwich panels offer a greater strength-to-weight ratio than traditional materials that are used by the building industry. The composite sandwich panels are generally as strong as, or stronger than, traditional materials including wood-based and steel-based structural insulation panels, while being lighter in weight. Because they weigh less than traditional building materials, the handling and transport of composite sandwich panels is generally less expensive. The composite sandwich panels also can be used to produce light-weight structures, such as floating houses, mobile homes, or travel trailers, etc.

Sandwich panels generally are more elastic or flexible than conventional materials such as wood, concrete, steel or brick and, therefore, monolithic (e.g., unitary or single unit structure) buildings made from sandwich panels generally are more durable than buildings made from conventional materials. For example, sandwich panels also may be non-flammable, waterproof, very strong and durable, and in some cases able to resist hurricane-force winds (up to 300 Kph (kilometers per hour) or more). The sandwich panels also may be resistant to the detrimental effects of algae, fungicides, water, and osmosis. As a result, buildings constructed from sandwich panels may be better able to withstand earthquakes, floods, tornados, hurricanes, fires and other natural disasters than buildings constructed from conventional materials.

Sandwich panel structures may be less expensive to build than structures built from conventional materials because of reduced material costs and alternative construction techniques. The ownership and maintenance costs for sandwich panel structures also may be less over the long term because sandwich panel structures may last longer and degrade at a slower rate than buildings made from conventional materials. Structures built from sandwich panels therefore may require less maintenance and upkeep than structures built from conventional building materials, which may reduce the overall ownership costs for end users.

The insulative core of the sandwich panels also may reduce the amount of energy needed to heat and/or cool the building, which may reduce the overall costs to operate the building. The insulative core also may reduce or eliminate the need for additional insulation in the building, as may be necessary to insulate structures built from conventional building materials. Sandwich panel structures therefore may be less expensive to build and operate than buildings constructed from conventional building materials.

Sandwich panels are generally constructed from one or more outer layers of laminate material and an insulative core. The outer layers of laminate may be formed from one or more layers of reinforcement material. Multiple layers of reinforcement material may be bonded together to form the laminate and to increase the strength and/or rigidity of the laminate and the sandwich panel.

The present invention uses an acetone solvent and, optionally, increased pressure of the acetone solvent to facilitate cleaning manufacturing equipment used to produce composite sandwich panels. As discussed below, the acetone solvent may be pumped by a fluid pump through the components of the manufacturing system that have been contaminated with, for example, adhesives, hardeners, resins, flame retardants, etc. A pressure tube may be installed in the acetone supply, so that during the cleaning process, a pressure valve will be opened, which will pressurize the acetone through the components of the manufacturing system in order to efficiently clean the various components used in the manufacturing process.

One aspect of the invention relates to a cleaning system for use in cleaning one or more components used to manufacture composite sandwich panels, the system including: a mixing manifold having a plurality of input ports for receiving production materials and an acetone solvent and at least one output port for outputting material that enters the mixing manifold; a source of the acetone solvent coupled to one of the input ports of the mixing manifold for cleaning one or more components used to manufacture composite sandwich panels; a first pump operatively coupled to the source to pressurize the acetone solvent prior to entry into the mixing manifold for pressurizing the acetone solvent in the mixing manifold; and a trough for receiving the acetone solvent.

Another aspect of the invention relates to a static mixer being coupled to the output port of the mixing manifold.

Another aspect of the invention relates to a nozzle being operatively coupled to the static mixer.

Another aspect of the invention relates to a second pump coupled between the through and the source of acetone for transferring the acetone solvent deposited in the trough to the source of acetone.

Another aspect of the invention relates to at least one input port of the mixing manifold being coupled to a resin source.

Another aspect of the invention relates to another input port of the mixing manifold being coupled to a hardener source.

Another aspect of the invention relates to the trough being movable to a first position when the cleaning system is in a manufacturing mode and a second position when the cleaning system is in a cleaning mode.

Another aspect of the invention relates to the trough not being used in the manufacturing process when the trough is in the first position.

Another aspect of the invention relates to the acetone solvent having an acetone concentration of at least 75% volume.

Another aspect of the invention relates to a valve being coupled between the source of acetone solvent and the input port to the mixing manifold.

Another aspect of the invention relates to the valve being manually operated.

Another aspect of the invention relates to the valve being an electrical valve that is controlled automatically by an algorithm executed by a processor.

Another aspect of the invention relates to a method for cleaning one or more components used to manufacture composite sandwich panels, the method including: receiving an acetone solvent through an input port of a mixing manifold, wherein the mixing manifold has a plurality of input ports for receiving production materials and the acetone solvent and at least one output port for outputting material that enters the mixing manifold; pressurizing the acetone solvent by a first pump prior to entry of the acetone solvent into the mixing manifold; and outputting the acetone solvent through the at least one output port of the mixing manifold.

Another aspect of the invention relates to receiving the acetone solvent in a trough.

Another aspect of the invention relates to moving the trough to a first position when the cleaning system is in a manufacturing mode and a second position when the cleaning system is in a cleaning mode.

Another aspect of the invention relates to transferring the acetone solvent received in the trough to a storage container.

Another aspect of the invention relates to the storage container being operatively coupled to at least one input port of the mixing manifold.

Another aspect of the invention relates to outputting the acetone solvent through a static mixer coupled to the mixing manifold.

Another aspect of the invention relates to outputting the acetone solvent through a nozzle coupled to the static mixer.

Another aspect of the invention relates to at least the mixing manifold, the static mixer and/or nozzle being supported by a cart that moves to a cleaning position over the trough when the cleaning system is in a cleaning mode and the cart is positioned over at least a portion of the production table when in a manufacturing mode.

These and further features of the present invention will be apparent with reference to the following description and attached drawings. In the description and drawings, particular embodiments of the invention have been disclosed in detail as being indicative of some of the ways in which the principles of the invention may be employed, but it is understood that the invention is not limited correspondingly in scope. Rather, the invention includes all changes, modifications and equivalents coming within the spirit and terms of the claims appended hereto.

It should be emphasized that the term “comprises/comprising” when used in this specification is taken to specify the presence of stated features, integers, steps or components but does not preclude the presence or addition of one or more other features, integers, steps, components or groups thereof.

Features that are described and/or illustrated with respect to one embodiment may be used in the same way or in a similar way in one or more other embodiments and/or in combination with, or instead of, the features of the other embodiments.

### BRIEF DESCRIPTION OF THE DRAWINGS

FIG. 1 is an isometric view of an exemplary sandwich panel.

FIG. 2 is a schematic view of a cleaning system for cleaning one or more components used to manufacture composite sandwich panels in accordance with aspects of the present invention.

FIG. 3 is an exemplary method in accordance with aspects of the present invention.

### DETAILED DESCRIPTION OF EMBODIMENTS

In the detailed description that follows, like components have been given the same reference numerals regardless of whether they are shown in different embodiments of the invention. To illustrate the present invention in a clear and concise manner, the drawings may not necessarily be to scale and certain features may be shown in somewhat schematic form. Certain terminology is used herein to describe the different embodiments of the invention. Such terminology is used only for convenience when referring to the figures. For example, “upward,” “downward,” “above,” or “below” merely describe directions in the configurations shown in the figures. The components can be oriented in any direction and the terminology should therefore be interpreted to include such variations. Furthermore, while described primarily with respect to house construction, it will be appreciated that all of the concepts described herein are equally applicable to the construction of any type building, such as warehouses, commercial buildings, factories, apartments, etc.

As set forth above, aspect of the present invention relate to an acetone based solvent applied with pressure to facilitate cleaning manufacturing equipment used to produce composite sandwich panels. The acetone solvent may be pumped by a fluid pump or an air driven pump through components of the manufacturing system that have been contaminated with, for example, adhesives, hardeners, resins, flame retardants, etc. A pressure tube may be installed in the acetone supply, so that during the cleaning process, e.g., by flushing with an acetone solvent, the pressure valve will be opened, which will pressurize the acetone through the components of the manufacturing system in order to efficiently clean the various components used in the manufacturing process.

Referring to FIG. 1, an exemplary sandwich panel 10 is illustrated. As used herein, the phrase “sandwich panel” means a panel having two outer layers 12, 14 separated by a core 16. The outer layers 12, 14 of the sandwich panel 10 are made from a composite material that includes a matrix material and a filler or reinforcement material. Exemplary matrix materials include a resin or mixture of resins, e.g., epoxy resin, polyester resin, vinyl ester resin, natural (or non oil-based) resin or phenolic resin, etc. Exemplary filler or reinforcement materials include fiberglass, glass fabric, carbon fiber, or aramid fiber, etc. Other filler or reinforcement materials include, for example, one or more natural fibers, such as, jute, coco, hemp, or elephant grass, balsa wood, or bamboo.

The outer layers 12, 14 (also referred to as laminates) may be relatively thin with respect to the panel core 16. The outer layers 12, 14 may be several millimeters thick and may, for example, be between about 1 mm (millimeter)-12 mm (millimeters) thick; however, it will be appreciated that the outer layers can be thinner than 1 mm (millimeter) or thicker than 12 mm (millimeters) as may be desired. In one embodiment, the outer layers are about 1-3 mm (millimeters) thick.

It will be appreciated that the outer layers 12, 14 may be made thicker by layering several layers of reinforcement material on top of one another. The thickness of the reinforcement material also may be varied to obtain thicker outer layers 12, 14 with a single layer of reinforcement material. Further, different reinforcement materials may be thicker than others and may be selected based upon the desired thickness of the outer layers.

The panel core 16 separates the outer layers 12, 14 of the sandwich panel 10. The panel core 16 may be formed from a light-weight, insulative material, for example, polyurethane, expanded polystyrene, polystyrene hard foam, Styrofoam® material, phenol foam, a natural foam, for example, foams made from cellulose materials, such as a cellulosic corn-based foam, or a combination of several different materials. Other exemplary panel core materials include honeycomb that can be made of polypropylene, non-flammable impregnated paper or other composite materials. It will be appreciated that these materials insulate the interior of the structure and also reduce the sound or noise transmitted through the panels, e.g., from one outer surface to the other or from an exterior to an interior of a building structure, etc. The panel core 56 may be any desired thickness and may be, for example, 30 mm (millimeters)-100 mm (millimeters) thick; however, it will be appreciated that the core can be thinner than 30 mm (millimeters) or thicker than 100 mm (millimeters) as may be desired. In one embodiment, the core is approximately 40 mm (millimeters) thick.

The outer layers 12, 14 are adhered to the core 16 with the matrix materials, such as the resin mixture. Once cured, the outer layers 12, 14 of the sandwich panel 10 are firmly adhered to both sides of the panel core 16, forming a rigid building element. It will be appreciated that the resin mixture also may include additional agents, such as, for example, flame retardants, mold suppressants, curing agents, hardeners, etc. Coatings may be applied to the outer layers 12, 14, such as, for example, finish coats, paint, ultraviolet (UV) protection, water protection, etc.

The panel core 16 may provide good thermal insulation properties and structural properties. The outer layers 12, 14 may add to those properties of the core and also may protect the panel core 16 from damage. The outer layers 12, 14 also may provide rigidity and support to the sandwich panel 10.

The sandwich panel 10 may include a first edge 18, a second edge 20, a third edge 22 and a fourth edge 24. The sandwich panels may be any shape and size. In one embodiment, the sandwich panels are rectangular in shape and may be several meters, or more, in height and width. The sandwich panels also may be other shapes and sizes. The combination of the panel core 16 and outer layers 12, 14 create sandwich panels with high ultimate strength, which is the maximum stress the panels can withstand, and high tensile strength, which is the maximum amount of tensile stress that the panels can withstand before failure. The compressive strength of the panels is such that the panels may be used as both load bearing and non-load bearing walls. In one embodiment, the panels have a load capacity of at least 50 tons per square meter in the vertical direction (indicated by arrows V in FIG. 1) and 1 tons per square meter in the horizontal direction (indicated by arrows H in FIG. 1). The sandwich panels may have other strength characteristics as will be appreciated in the art.

Internal stiffeners may be integrated into the panel core 16 to increase the overall stiffness of the sandwich panel 10. In one embodiment, the stiffeners are made from materials having the same thermal expansion properties as the materials used to construct the panel, such that the stiffeners expand and contract with the rest of the panel when the panel is heated or cooled.

The stiffeners may be made from the same material used to construct the outer layers of the panel. The stiffeners may be made from composite materials and may be placed perpendicular to the top and bottom of the panels and spaced, for example, at distances of about 15 cm (centimeters), 25 cm, 50 cm, or 100 cm. Alternatively, the stiffeners may be placed at different angles, such as a 45-degree angle with respect to the top and bottom of the panel, or at another angle, as may be desired.

Referring to FIG. 2, a system 100 for providing cleaning materials (e.g., acetone solvent) to clean manufacturing components utilized to make one or more sandwich panels 10 is illustrated. The system 100 includes one or more storage containers 102, 104, 106 for supplying materials to a mixing manifold 108. For example, storage container 102 may store resin materials, storage container 104 may store acetone solvent and storage container 106 may store hardener material. One of ordinary skill in the art will readily appreciate that additional materials may also be supplied to the mixing manifold 108 (e.g., additives, flame retardant).

The mixing manifold 108 includes corresponding ports 110, 112, 114 coupled to the storage containers for receiving the materials contained the storage containers 102, 104, 106. For example, storage container 102 may be coupled to port 110, storage container 104 may be coupled to port 112, and storage container 106 may be coupled to port 114. Each of the input ports may have separate valves (not shown) that control the release of materials into the mixing manifold 108 from the respective sources. The valves may be operated manually and/or controlled electronically as part of automated process control. For example, during production of sandwich panels, it may be desirable to mix components of resin stored in container 102 with hardener stored in container 106. During the cleaning process, it may desirable to only allow flow from the container 104 that contains an acetone solvent into the mixing manifold and prevent the flow of production materials (e.g., resin, hardener, flame retardant, etc.) into the mixing manifold 108, for example.

During the manufacturing process, the mixing manifold 108 may contain components of resin, hardener, flame retardant or other materials that may be applied over a production table (not shown), for example, to manufacture sandwich panels. After a number of production runs, it may be desirable to clean one more components of the manufacturing equipment used in the manufacturing process to remove excess material build-up, for routine maintenance, and/or any other desired purpose.

The components of the manufacturing equipment (e.g., the mixing manifold 108, the static mixer 116 and nozzle 118) are generally positioned on a mobile unit, such as a cart that allows the components to move across the production table during the manufacturing process.

During the cleaning process, the components of the manufacturing equipment may be cleaned by pumping an acetone solvent through the production system 100. The acetone solvent may be any commercially available acetone solvent. The valves that control the resin and hardener may be closed so that additional resin and/or hardener materials do not enter the mixing manifold 108 during the cleaning process (e.g., when the acetone solvent enters the mixing manifold 108).

The mixing manifold 108 includes an output port 120 that outputs the acetone solvent and remaining debris in the manifold during the cleaning process. The output port 120 of the mixing manifold 108 is coupled to a static mixer 116. The output of the static mixer 116 is output through a nozzle 118 to an acetone trough 122, which collects the acetone solvent and any waste materials. In general, pressurized acetone solvent is transferred through the nozzle 118 and received by the trough 122, as illustrated in FIG. 2.

In one embodiment, prior to the re-circulation of acetone solvent, the to components of resin, hardener, flame retardant or other materials that may be used in the manufacturing process are output to a resin trough 123. The resin trough 123 may be smaller in size than the acetone trough 122. The resin trough 123 may be positioned within or adjacent to the acetone trough 122. For example, once the resin trough 123 receives the vast majority of the manufacturing components (e.g., resin, hardener, flame retardant, etc.) left in the system, the resin trough 123 may be moved or the cart holding carrying the components of the manufacturing equipment (e.g., the mixing manifold 108, the static mixer 116 and nozzle 118) may be moved to over the acetone trough 122. In another embodiment, the acetone trough may be moved to receive acetone solvent during the cleaning process.

The initial removal of the manufacturing components generally takes a few seconds and the contents of the resin trough 123 may be disposed. One benefit of utilizing resin trough 123 is to keep the bulk of the manufacturing components out of the circulated cleaning system, which allows for extended use of the acetone solvent supply.

Once the initial removal of manufacturing components (e.g., resin, hardener, additives, flame retardant) is complete, acetone solvent is received throughout the system and deposited into the acetone trough 122. For re-circulation, a pump 124 (e.g., a fluid or air pump) may pump the acetone solvent from the acetone trough 122 back to the acetone supply container (e.g., acetone storage container 104). The output of the acetone trough may have a filter for holding back larger particles from the acetone solvent. The pump 124 generally is capable of transferring the contents of the acetone trough 122 to the acetone source 104 via a transfer pipe 126. When the acetone solvent may no longer be used, the transfer pipe from the pump to the storage container may be disconnected for transferring the acetone solvent by the pump to a waste container.

In order to achieve a better cleaning result, a pressure pipe 128 (e.g., an air pressure pipe) is connected to the acetone supply line prior to the mixing manifold 108 and/or at the mixing manifold 108. A pump 130 (e.g., a fluid or air pump) pressurizes the acetone solvent through the mixing manifold 108, the static mixer 116, the nozzle 118 into the acetone trough 122 via the pressure pipe 128.

The pressurized acetone solvent has been found to efficiently clean the various components of the manufacturing process. The acetone solvent is a commercial grade standard clean solvent. It has been determined that the acetone solvent may be used up to approximately 10 cleaning cycles. When the acetone solvent is no longer sufficiently effective the acetone solvent may be pumped or otherwise transferred to a waste container and a supply of acetone solvent may be provided to the acetone storage container (e.g., storage container 104).

A method 200 for cleaning one or more components used to manufacture composite sandwich panels is illustrated in FIG. 3. At block 202, the method includes receiving an acetone solvent through an input port (e.g., input port 112) of mixing manifold 108. As described above, the mixing manifold 108 has a plurality of input ports (e.g., input ports 110, 112, 114) for receiving production materials and cleaning materials and at least one output port 120 for outputting material that enters the mixing manifold 108.

At block 204, optionally, the acetone solvent may be pressurized prior to entry into the mixing manifold and/or may be pressurized in the mixing manifold 108. The acetone solvent may be pressurized with fluid and/or air provided by a first pump 130, which may be coupled to the mixing manifold 108 and/or a supply line associated with the acetone solvent. Pressurizing the acetone solvent has been found to provide better cleaning results than outputting the acetone solvent without pressurization.

At block 206, the acetone solvent is output through the at least one output port 120 of the mixing manifold 110. Optionally, at block 208 the acetone solvent may also be output through the static mixer 116. In addition, optionally, at block 210 the acetone solvent may also be output through the nozzle 118.

At block 211, if the acetone is not being re-circulated, at block 212, the bulk of the remaining manufacturing components and acetone solvent may received by the resin trough 123 prior to initiation of re-circulating the acetone solvent. This initial removal of the manufacturing components generally takes a few seconds and the contents of the trough 123 may be disposed of, for example at block 214.

If the acetone solvent is being re-circulated flow from block 210 goes to block 216. At block 216, a cart carrying the mixing manifold 108, the static mixer and/or nozzle 118 may be positioned over the acetone trough or the acetone trough 122 may be positioned to receive the acetone solvent that is output from at least one of the mixing manifold 108, the static mixer 116 and/or the nozzle 118. For example, in one embodiment, a cart carrying the mixing manifold 108, the static mixer 116 and/or the nozzle 118 may be positioned over the acetone trough 122 when it is desired to clean one or more of the manufacturing equipment components. The cart supports at least the mixing manifold, the static mixer and/or nozzle that moves to a cleaning position over the trough when the cleaning system is in a cleaning mode and the cart is positioned over at least a portion of the production table when in a manufacturing mode.

In another embodiment, the acetone trough 122 is moved to a first position when the cleaning system 100 is in a manufacturing mode. During the manufacturing mode, the cleaning system is generally not operative. When it is time to clean one or more components of the system 100, the acetone trough 122 is moved to a second position, which is generally underneath at least one of the mixing manifold 108, the static mixer 116 and/or the nozzle 118 when the system is in a cleaning mode in order to receive the acetone solvent that has been flushed through the one or more components of the system.

At block 218, the acetone solvent received in the trough 122 may be transferred to a storage container (e.g., storage container 104). Preferably, the storage container is operatively coupled to at least one input port (e.g., input port 112) of the mixing manifold 110, for re-circulating the acetone solvent. This allows to the acetone solvent to be re-used for cleaning the components of the manufacturing system, which provides costs efficiencies and is environmentally friendly.

In order to maintain clean the system, filters 132A-132C may be positioned throughout the system. For example, a filter 132A may be positioned at the output port of the acetone solvent source 104 (e.g. between the source 104 and the pump 130 and/or between the source 104 and the mixing manifold 108). In addition, a filter 132B may be positioned between the acetone trough 122 and the pump 124 in order to remove debris between the acetone trough 122 and the pump 124. In addition, a filter 132C may be positioned between the output of the pump 124 and the acetone source 104. The filters function to remove debris from the acetone solvent, so that debris that is removed during the cleaning process is not re-circulated in the system during the cleaning process.

Although the invention has been shown and described with respect to a certain preferred embodiment or embodiments, it is obvious that equivalent alterations and modifications will occur to others skilled in the art upon the reading and understanding of this specification and the annexed drawings.

What is claimed is:

1. A cleaning system for use in cleaning one or more components used to manufacture composite sandwich panels, the system comprising:
a mixing manifold having a plurality of input ports for receiving production materials and an acetone solvent and at least one output port for outputting material that enters the mixing manifold;
a source of the acetone solvent coupled to one of the input ports of the mixing manifold for cleaning one or more components used to manufacture composite sandwich panels;
a first pump operatively coupled to the source to pressurize the acetone solvent prior to entry into the mixing manifold for pressurizing the acetone solvent in the mixing manifold; and
a trough for receiving the acetone solvent.

2. The cleaning system of claim 1 further including a static mixer coupled to the output port of the mixing manifold.

3. The cleaning system of claim 2 further including a nozzle operatively coupled to the static mixer.

4. The cleaning system of claim 1, further including a second pump coupled between the trough and the source of acetone for transferring the acetone solvent deposited in the trough to the source of acetone.

5. The cleaning system of claim 1, wherein at least one input port of the mixing manifold is coupled to a resin source.

6. The cleaning system of claim 5, wherein another input port of the mixing manifold is coupled to a hardener source.

7. The cleaning system of claim 1, wherein the trough is movable to a first position when the cleaning system is in a manufacturing mode and a second position when the cleaning system is in a cleaning mode.

8. The cleaning system of claim 7, wherein the trough is not used in the manufacturing process when the trough is in the first position.

9. The cleaning system of claim 1, wherein a valve is coupled between the source of acetone solvent and the input port to the mixing manifold.

10. The cleaning system of claim 1, wherein the valve is manually operated.

11. The cleaning system of claim 1, wherein the valve is an electrical valve that is controlled automatically by an algorithm executed by a processor.

12. A method for cleaning one or more components used to manufacture composite sandwich panels, the method comprising:
receiving an acetone solvent through an input port of a mixing manifold, wherein the mixing manifold has a plurality of input ports for receiving production materials and the acetone solvent and at least one output port for outputting material that enters the mixing manifold;
pressurizing the acetone solvent by a first pump prior to entry of the acetone solvent into the mixing manifold; and
outputting the acetone solvent through the at least one output port of the mixing manifold.

13. The method of claim 12 further including receiving the acetone solvent in a trough.

14. The method of claim 12, further including moving the trough to a first position when the cleaning system is in a manufacturing mode and a second position when the cleaning system is in a cleaning mode.

15. The method of claim 14 further including transferring the acetone solvent received in the trough to a storage container.

16. The method of claim 15, wherein the storage container is operatively coupled to at least one input port of the mixing manifold.

17. The method of claim 12, further including outputting the acetone solvent through a static mixer coupled to the mixing manifold.

18. The method of claim 17 further including outputting the acetone solvent through a nozzle coupled to the static mixer.

19. The method of claim 13, wherein at least the mixing manifold, the static mixer and/or nozzle are supported by a cart that moves to a cleaning position over the trough when the cleaning system is in a cleaning mode and the cart is positioned over at least a portion of the production table when in a manufacturing mode.
